(19) United States
(12) Patent Application Publication
(10) Pub. No.: US 2005/0243363 A1
(43) Pub. Date: Nov. 3, 2005

(54) Printing system, method for managing print job, program, and recording medium

(75) Inventor: Shin Muto, Kawasaki-shi (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/109,179

(22) Filed: Apr. 19, 2005

(30) Foreign Application Priority Data
Apr. 28, 2004 (JP) 2004-132966
Feb. 24, 2005 (JP) 2005-048811

(51) Int. Cl. G06F 15/00

(52) U.S. Cl. 358/1.15; 358/448

(57) ABSTRACT

In a printing system, a printing apparatus receives a request for acquiring job management information stored in a processing wait queue of the printing apparatus. The printing apparatus also receives check information. The printing apparatus creates job management information capable of identifying an order of printing of submitted jobs matching and not matching the check information. The job management information includes simplified job information created by removing at least part of information from job information of a submitted job not matching the check information and job information of the submitted job matching the check information.

### BACKGROUND OF THE INVENTION

1. Field of the Invention

The present invention relates to a scheme for controlling display of job processing information in printers capable of spooling print jobs before printing.

2. Description of the Related Art

Recently, many printing apparatuses, such as regular printers and multifunction printers, are equipped with a network interface to connect a LAN (local area network) in office environments or homes, and are used in connection with various types of information processing apparatuses, such as host computers and server computers.

Under such circumstances, Japanese Patent Laid-Open No. 8-194588 discloses a technology in which the display of a job list of print jobs spooled in a printing apparatus is changed in accordance with the change in print job status. However, in this technology, all the job information in the printing apparatus is displayed when monitoring the processing status of print jobs in the printing apparatus. Accordingly, the status and the information of another user's print job can be viewed. This causes a security or privacy problem.

To solve this problem, Japanese Patent Laid-Open No. 11-65787 discloses a technology in which a user inputs his or her own information to a host computer and if job information (e.g., job status) retrieved from a printer matches the user information, the job information is delivered to a utility. As a result, the user can view only information associated with his or her own jobs. In other words, Japanese Patent Laid-Open No. 11-65787 discloses a technology that increases the security level by preventing a user from viewing another user's job.

However, although the technology disclosed in Japanese Patent Laid-Open No. 11-65787 has an advantage in that it ensures security, the technology does not satisfy the requirement for the originally expected job management functions, for example, the function for managing the current operating status of the printing apparatus and the queue status of the subsequent print outputs. Furthermore, this technology has a disadvantage in that it is difficult for a user to view the status of his or her own jobs at a glance when many print jobs are spooled in the printing apparatus.

### SUMMARY OF THE INVENTION

Accordingly, the present invention is conceived as a response to the above-described disadvantages of the conventional art.

According to the present invention, a printing system can provide a scheme for achieving security or privacy protection while improving an original job management function.

According to one aspect of the present invention, a printing system includes a processing wait queue capable of identifying an order of printing of submitted jobs, a storing unit configured to store a submitted job in the processing wait queue, a receiving unit configured to receive both a request for acquiring job management information and check information on the submitted job stored in the processing wait queue, a creation unit configured to create job management information including simplified job information created by removing at least part of information from job information of a submitted job not matching the check information and job information of a submitted job matching the check information, and an output control unit configured to cause the job management information created by the creation unit to be externally output. The job management information is capable of identifying the order of printing of the submitted jobs matching and not matching the check information.

According to another aspect of the present invention, a printing system includes a processing wait queue capable of identifying an order of printing of submitted jobs, a storing unit configured to store a submitted job in the processing wait queue, a receiving unit configured to receive both a request for acquiring job management information and check information on the submitted job stored in the processing wait queue, a creation unit configured to create job management information including job information of a submitted job matching the check information and being capable of identifying the order of printing of the submitted jobs matching and not matching the check information, and an output control unit configured to cause the job management information created by the creation unit to be externally output.

Other features and advantages of the present invention will be apparent from the following description taken in conjunction with the accompanying drawings, in which like reference characters designate the same or similar parts throughout the figures.

### BRIEF DESCRIPTION OF THE DRAWINGS

FIG. 1 is a block diagram of a printing control system including an information processing apparatus and a printing apparatus according to the present invention.

FIG. 2 shows an example of a sequence diagram illustrating a communication procedure in the printing system according to the present invention.

FIG. 3 shows an example of a printer status monitoring screen displayed on a CRT shown in FIG. 1.

FIG. 4 shows an example of a printer status monitoring screen displayed on the CRT shown in FIG. 1.

FIG. 5 shows a screen example of job management information displayed on the CRT shown in FIG. 1.

FIG. 6 shows a screen example of job management information displayed on the CRT shown in FIG. 1.

FIG. 7 shows a flow chart illustrating an example of a response procedure to a request for acquiring job management information in a printing system according to the present invention.

FIG. 8 shows a flow chart illustrating an example of a response procedure to a request for acquiring job management information in the printing system according to the present invention.

FIG. 9 shows a screen example of job management information displayed on the CRT shown in FIG. 1.

FIG. 10 shows a flow chart illustrating an example of a response procedure to a request for acquiring job management information in a printing system according to the present invention.

FIG. 11 shows an example of job information registered in a print processing queue of the printing system according to the present invention.

FIG. 12 shows a memory map of a recording medium for storing a variety of computer-readable data processing programs.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

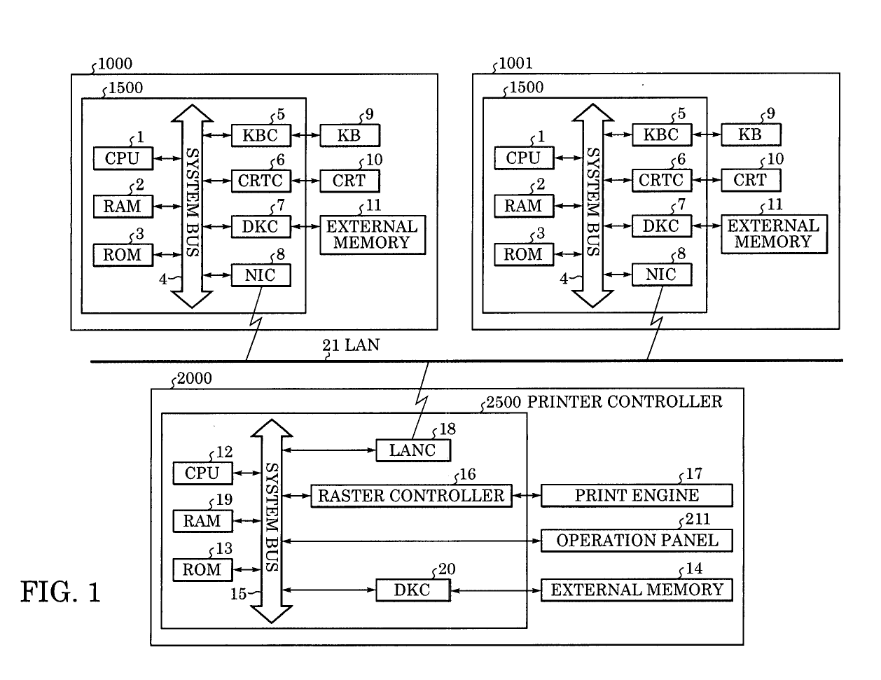

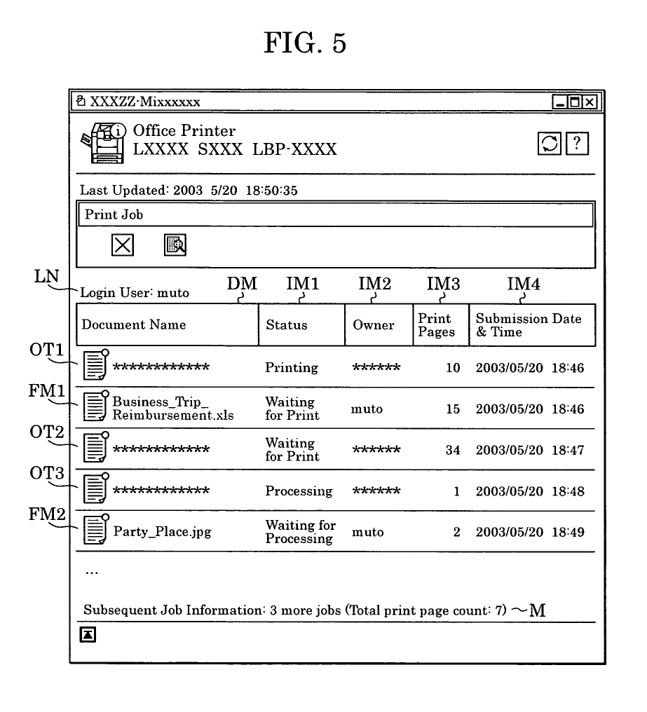

FIG. 1 is a block diagram of a printing control system including an information processing apparatus and a printing apparatus according to a first embodiment of the present invention. In this embodiment, a laser printer is used as an example of the printing apparatus. A host computer 1000 and a printer 2000 can communicate with each other via a LAN 21 using a predetermined protocol. A plurality of information processing apparatuses having identical or comparable hardware to the host computer 1000 (e.g., host computer 1001) are connected to the LAN 21. The printer 2000 can communicate with the plurality of information processing apparatuses 1000, 1001 to hold or spool a plurality of print jobs delivered from the plurality of information processing apparatuses at a given time. Additionally, the printer 2000 includes a print wait queue (not shown) in order to manage each print job received from the host computers 1000, 1001 by adding a print output order (print priority) attribute to the print job. Each job in each queue is managed in association with a variety of print job attribute information (job information) shown in FIGS. 5, 6, 9, and 11.

As shown in FIG. 1, the host computer 1000 is a commonly used host computer including a motherboard 1500 on which basic system devices are mounted. The motherboard 1500 incorporates a variety of control devices for controlling a variety of input and output devices. The control devices are described below.

In the motherboard 1500, a CPU (central processing unit) 1 loads an OS (operating system) from an external memory 11 based on a BIOS (basic input output system) program stored in a program ROM (read-only memory) area of a ROM 3 and performs overall control of each device connected to a system bus 4 using a RAM (random access memory) 2 as a main memory and a work memory.

A keyboard controller (KBC) 5 controls key input from a keyboard (KB) 9 and a pointing device (not shown). A CRT controller (CRTC) 6 controls display on a CRT display (CRT) 10. A disk controller (DKC) 7 controls access to the external memory 11, such as a flexible disk (FD) and a hard disk (HD), which stores the OS, a variety of applications, font data, user files, and a virtual memory.

A network interface controller (NIC) 8 is connected to the LAN 21 via a network interface for a predetermined network, such as the Ethernet, to carry out a communication control process with the printer 2000 connected to the LAN 21 in the same manner.

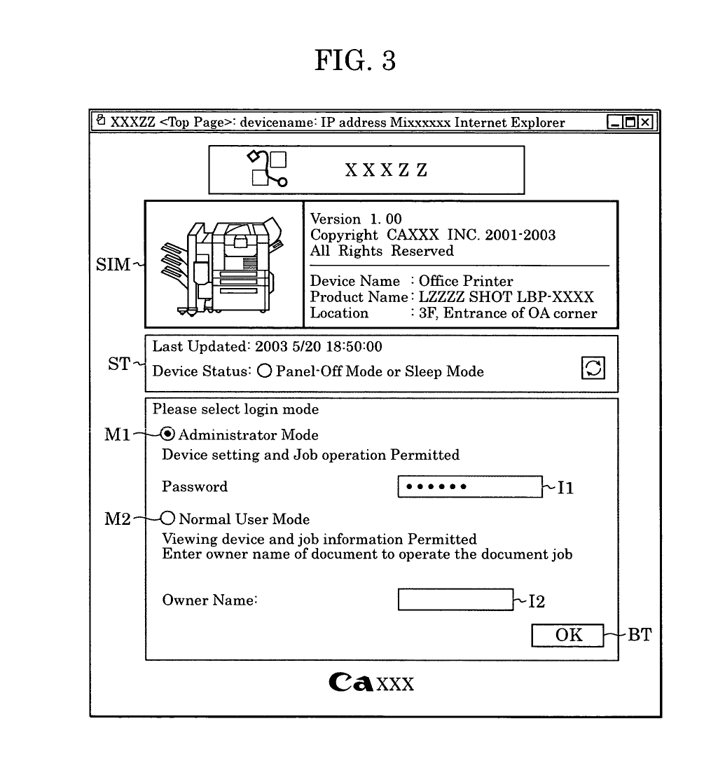

In the communication control process, the host computer 1000 outputs print data to the printer 2000. In addition, the host computer 1000 acquires WEB content (HTML data and a bitmap image) including device information shown in FIGS. 3, 4, 5, and 6 (described below) from the printer 2000 using, for example, the HTTP protocol (RFC1945 and RFC2616). The host computer 1000 then displays the WEB content on the CRT 10 using a commonly used WEB browser application. That is, the host computer 1000 can acquire a variety of information about the printer 2000 to control the printer 2000 by using a graphical user interface (GUI). It should be noted that the HTML data may be replaced with any type of markup language data.

The external memory 11 of the host computer 1000 stores a printer driver and a print utility, which are software required for the print control. Also, the external memory 11 stores UI (user interface) screens used for a user to start the print utility and input an instruction by operating the keyboard 9 and a pointing device (not shown). By executing a control program, the host computer 1000 displays a print status monitoring screen on the CRT 10 under the control of the CPU 1 based on job list and job information received from the printer 2000. Thus, the host computer 1000 separately displays its own job status information and other job status information while ensuring security. The UI screens, the control program, and the print status monitoring screen are described below.

In this embodiment, the details of the print state monitoring UI for a normal user can be different from those for an administrator of the printing system. That is, it is one of the specific features of the embodiment that the job information for monitoring a print status can be changed depending on a user level.

Additionally, in this embodiment, the details and the amount of data for a job list required by a user are different from those for a job list which other users submit prior to the user's job (both job lists are created by the printer 2000). Furthermore, in this embodiment, other users' job information of a job subsequent to the user's job is not displayed in order to reduce the communication load involved in acquiring the job list information. Other examples for displaying the job information are described below.

The printer 2000 includes a printer controller 2500 incorporating a variety of control devices connected to a system bus 15. The control devices are described below. Additionally, the printer controller 2500 includes the above-described print wait queue for a submitted print job.

A printer CPU (CPU) 12 performs overall control of access to a variety of the devices connected to the system bus 15 under the control of a control program stored in a program area of a ROM 13 or a control program stored in an external memory 14 to output an image signal as output information to a print engine 17 via a raster controller 16. Then, the print engine 17 sequentially prints the image signal on a recording medium in accordance with the printing order (print priority) assigned to each job managed by the print wait queue.

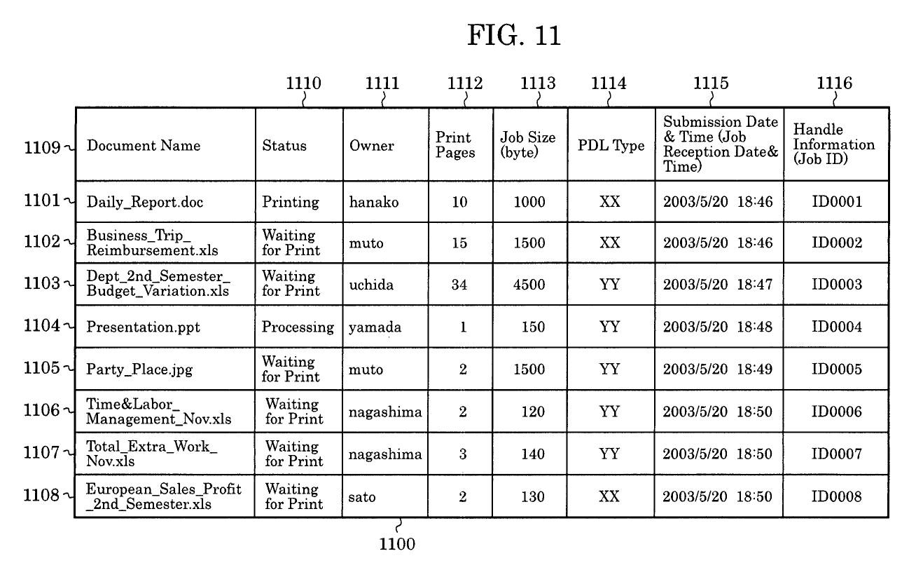

Upon receiving a request for acquiring job list information from the host computer 1000, the CPU 12 loads a control program for creating a job list stored in the external memory 14 to a RAM 19. The CPU 12 then executes the control program so as to collect information in the job queue managed in the RAM 19 and create simple text data to be delivered to a dedicated UI in the host computer 1000. Thereafter, a LAN controller (LANC) 18 transfers the created job list information to the host computer 1000 via the LAN 21. FIG. 11 shows an example of the information in the job queue managed in the RAM 19. Items 1100 correspond to the job information. Each item shown in FIGS. 5, 6, and 9 corresponds to one of items 1109 to 1116. These items in FIGS. 5, 6, and 9 are described below. Although actual print data is not shown in FIG. 11, the actual print data is linked to each job information item indicated as a row.

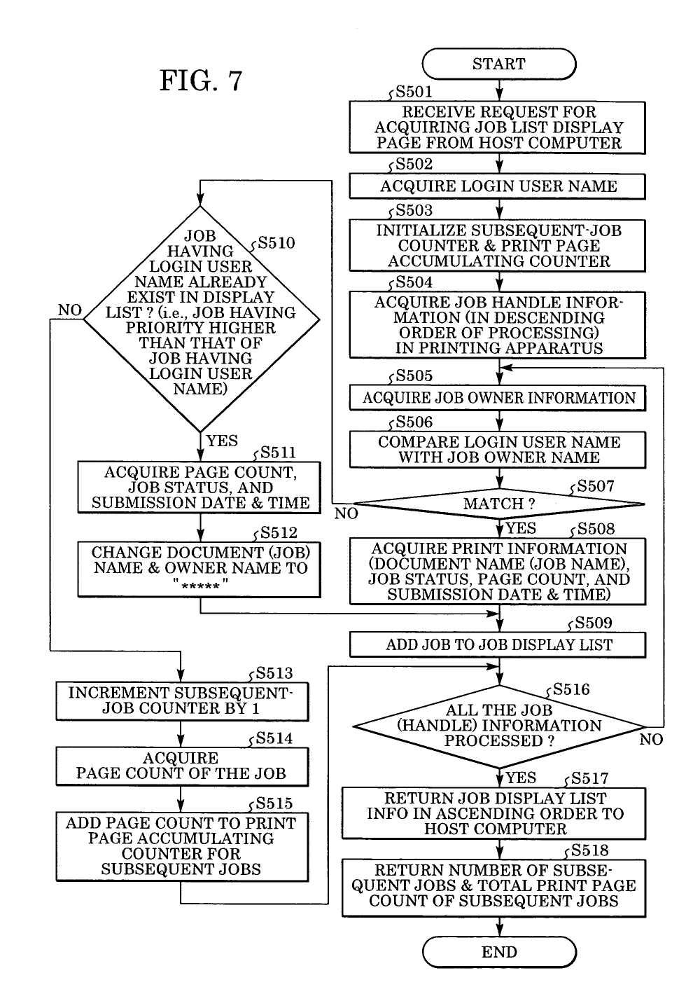

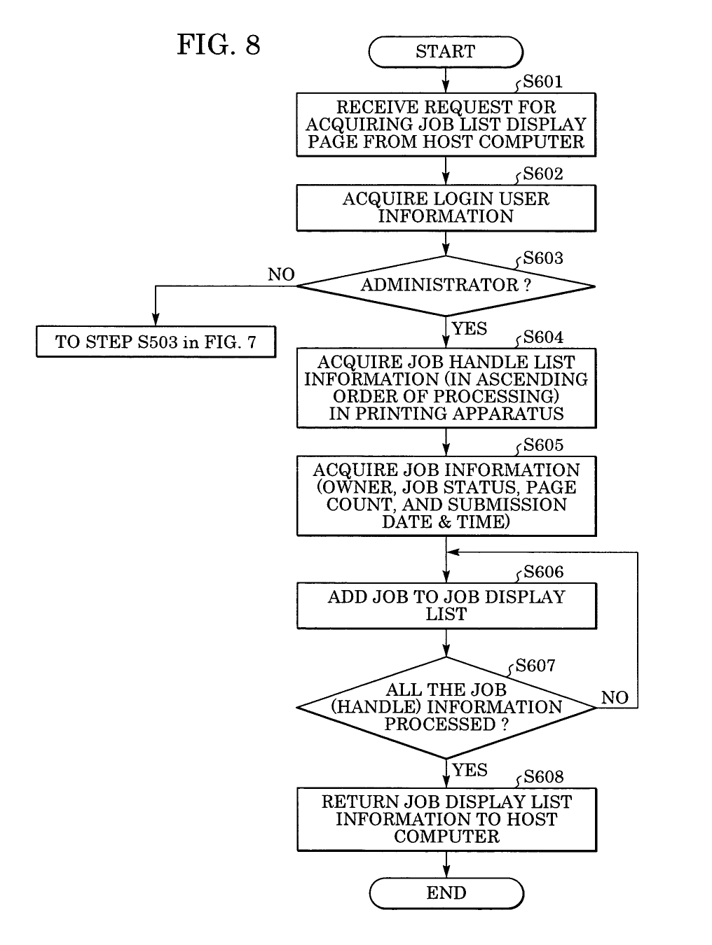

The program area of the ROM 13 also stores a control program for the CPU 12 and a WEB server program for providing WEB content, as shown by a flow chart in FIGS. 7 and 8. A font area of the ROM 13 stores font data used for creating the output information delivered to the print engine 17. In addition, in the case where the printer has no external memory 14, such as a hard disk, the font area stores a variety of information (e.g., setting information and WEB content) used by the host computer. Furthermore, by the CPU 12 executing a control program stored in the external memory 14, the printer 2000 provides a WEB server function for allowing access to a URL (not shown) via the LAN 21 to retrieve content of a home page and a WEB print process at any time.

The LANC 18 is connected to a plurality of host computers 1000 via a predetermined network interface and the LAN 21. The LANC 18 provides communication with the host computer 1000 under the control of the CPU 12. Thus, the LANC 18 allows print data received from the host computer 1000 and allows a variety of information in the printer to be transmitted in response to a request from the host computer 1000.

The RAM 19 serves as a main memory and a work area of the CPU 12. The size of the RAM 19 can be expanded by adding optional RAM to an expansion port (not shown).

The RAM 19 also serves as an area for expanding output information. Furthermore, a nonvolatile random access memory (NVRAM) is provided for storing a variety of print setting information and network address setting information. The external memory 14, such as a hard disk (HD) and an IC card, is controlled by a disk controller (DKC) 20.

The external memory 14 is optionally connected to stored font data, an emulation program, and form data. On an operation panel 211, operation switches and LED (light emitting diode) and LCD (liquid crystal display) indicators for displaying the printer status and the setting information are arranged.

According to the present invention, an interface connected to the LANC 18 is not limited to an Ethernet interface. Any communication medium that allows network communication, such as an IEEE 1394 LAN and a wireless LAN, may be employed.

Furthermore, the LANC 18 may be configured as a removable network card and may be replaced with another removable network card that supports another communication medium.

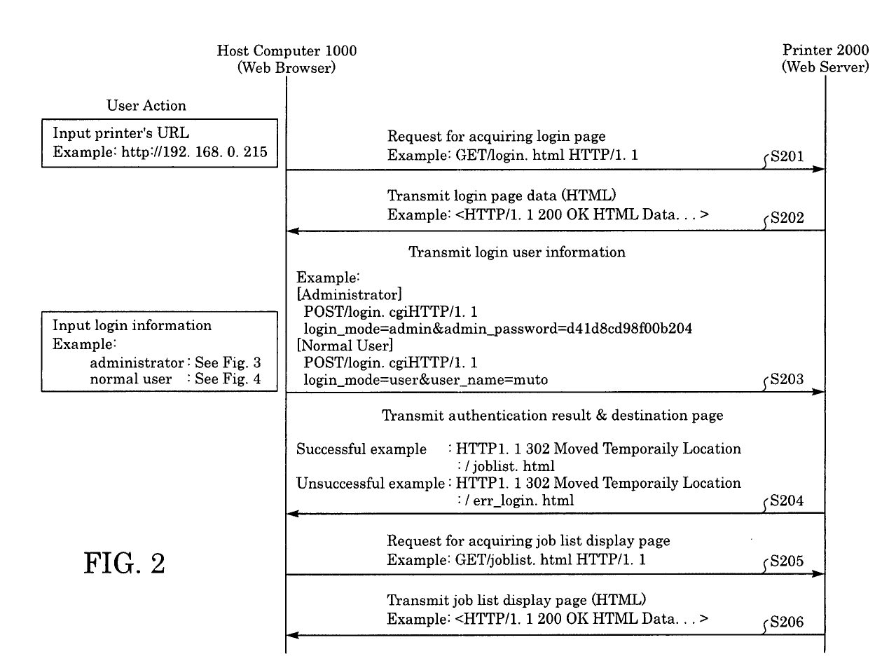

The present invention is described next using a printing system having such a configuration with reference to sequence diagrams and flow charts shown in FIG. 2 and the subsequent figures.

FIG. 2 shows an example of a sequence diagram illustrating a communication procedure in the printing system according to the present invention. In FIG. 2, the host computer 1000 acquires a list of processing statuses of print jobs in the printer 2000 as WEB content using, for example, the HTTP protocol, and the WEB content is displayed by a WEB browser running on the host computer 1000. In FIG. 2, phases S201 to S206 are shown.

To carry out transmission and reception processes in the host computer 1000 and the printer 2000, the CPU 1 and the CPU 12 execute programs stored in the external memory 11 and the ROM 13 of respective units.

When a user (operator) of the host computer 1000 inputs a URL of the printer 2000 (e.g., http://<printer's IP address>/) from, for example, the keyboard 9, the host computer 1000 transmits a request for receiving WEB content of a login page to the printer 2000 at phase S201. Thereafter, upon receipt of the request for the login page, a WEB server running on the printer 2000 transmits, to the host computer 1000, the HTML data of the login page stored in the ROM 13 or the external memory 14 of the printer 2000 in phase S202.

In phase S202, the WEB browser on the host computer 1000 then displays the login page shown in FIG. 3 as a graphical user interface (GUI) based on the HTML data received from the printer 2000.

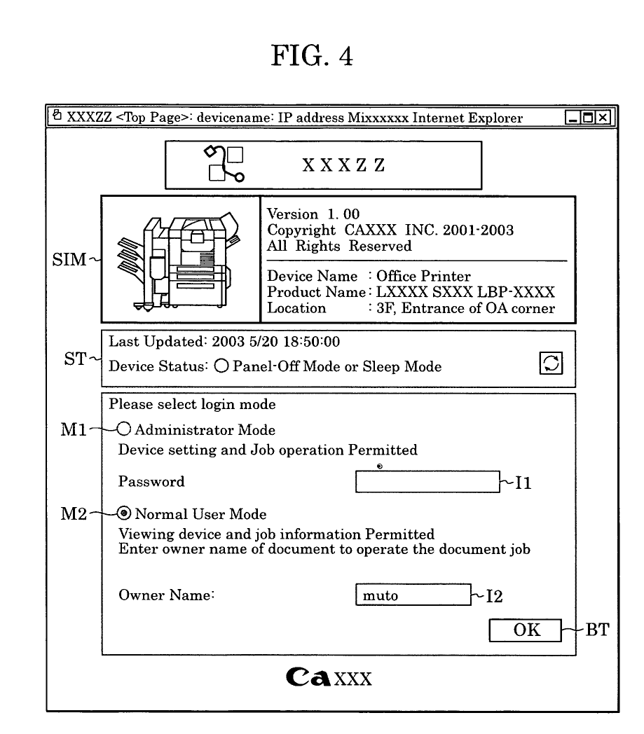

FIGS. 3 and 4 show examples of a printer status monitoring screen displayed on the CRT 10 shown in FIG. 1. In this embodiment, two status monitoring modes are provided: an administrator mode shown in FIG. 3 and a normal user mode shown in FIG. 4. These modes permit two login modes. Additionally, this screen is displayed by the CRTC 6 retrieving UI data pre-stored in the external memory 11 under the control of the CPU 1.

As shown in FIGS. 3 and 4, the user of the host computer 1000 selects an administrator mode M1 or a normal user mode M2 as a login mode via the WEB browser. When the user selects the administrator mode M1, the user operates the keyboard 9 to further input a password 11 for administrator authentication to a guide.

However, when the user selects the normal user mode M2, the user operates the keyboard 9 to input a user name 12, as shown in FIG. 4, to a guide.

The user then depresses an “OK” button BT on a screen shown in FIG. 3 or 4. In phase S203, the login information input by the user is transmitted to the printer 2000 using the HTTP protocol.

In an example of the administrator mode M1 in phase S203, the password for administrator authentication in the login information is encrypted into encrypted text data by using a predetermined cipher algorithm and is then transmitted.

When the printer 2000 receives the login information in phase S203, the CPU 12 of the printer 2000 carries out a login authentication determination process in accordance with the control program stored in the external memory 14. After the authentication determination process, the CPU 12 returns WEB content information (a destination page) available after the authentication as HTML data to the host computer 1000 in phase S204.

In phase S204, for example, if the login authentication is successful, the printer 2000 returns a URL of a print job list display page (/joblist.html) as WEB content information to the host computer 1000.

However, if, in phase S204, the authentication password is not authorized in the administrator mode M1, the printer 2000 returns an error page indicating unsuccessful authentication (/err_login.html) to the host computer 1000.

Thereafter, in phase S205, the WEB browser on the host computer 1000 requests the printer 2000 to send the WEB content corresponding to the URL information in the HTML data returned in phase S204. In phase S206, the printer 2000 creates HTML data for the requested WEB content based on the authentication result determined in phase S204 and returns the HTML data to the host computer 1000.

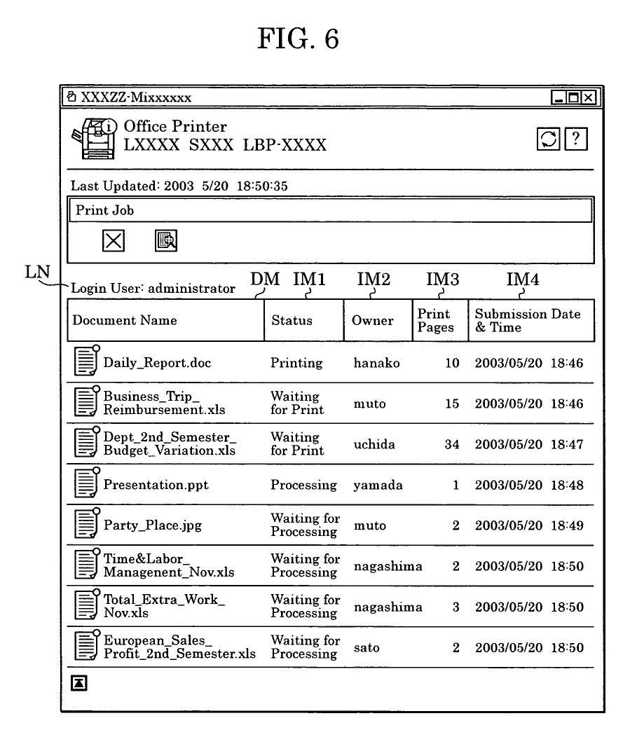

The HTML data returned in phase S206 is displayed by the host computer 1000. For example, if the authentication is successful, print job list pages created in accordance with the input login information are displayed on the WEB browser, as shown in FIGS. 5 and 6.

FIGS. 5 and 6 show screen examples of the print job list pages displayed on the CRT 10 shown in FIG. 1. In this embodiment, two status monitoring modes are provided: the administrator mode shown in FIG. 6 and the normal user mode shown in FIG. 5.

As shown in FIG. 5, a login user name LN represents, for example, a user name “muto”.

Monitor information IM1 indicates the status of a print job, where status of each print job in the displayed list, such as “printing” and “waiting for print” are displayed. Monitor information IM2 indicates the owner of the print job. If the login user is an owner of the print job, the name of the login user is displayed in the monitor information IM2.

Monitor information IM3 indicates the number of print pages, and monitor information IM4 indicates the submission date and time of the job.

Document name DM indicates a document name. The documents of an owner who is the login user are displayed. For example, file names FM1 and FM2 are directly displayed. However, the documents of an owner who is not the login user are displayed as unique masked names OT1, OT2, and OT3 showing meaningless symbols, for example, “*”S. The “*” data are generated by the printer 2000.

A message M displays characters. If a spooled job subsequent to the last job of an owner who is the login user exists in the printer 2000, a simple text message is displayed as the subsequent job information. For example, as shown in FIG. 5, if a spooled document name DM subsequent to a document name FM2 exists, the text “3 more jobs (Total print page count: 7)” is simply displayed. The present invention also includes a display scheme in which the status of a single subsequent job or a plurality of subsequent jobs is visually displayed with graphics and icons.

FIG. 6 shows the status of print jobs in the case of a login in the administrator mode M1. Compared with the print job monitoring display in FIG. 5, all of the document names are displayed. That is, when a user logs in in the normal user mode M2, job information on other users is displayed as masking characters and only the job spool status is displayed. This increases the security level and eliminates unnecessary data transfer. Thus, this method reliably prevents any user from viewing the detailed print job status information. Also, this method allows a user having administrator authority to freely set up a monitor environment for checking the detailed print job status information.

FIG. 5 shows an example of a screen in the case where a user inputs “muto” as a login name in the normal user mode M2, whereas FIG. 6 shows an example of a print job list page in the case where a user logs in in the administrator mode M1.

A procedure of the printer 2000 for processing a job display list in the sequence shown in FIG. 2 will be further described with reference to flow charts in FIGS. 7 and 8.

FIG. 7 shows a flow chart illustrating an example of a first data processing procedure in a printing apparatus according to the present invention. This data processing procedure corresponds to a process for generating a print job list page to be returned in phase S206 of FIG. 2 and its returning process when login information transmitted from the host computer 1000 in phase S203 of FIG. 2 is in a normal user mode. Control procedures in steps S501 to S518 are stored, as control programs, in the ROM 13 of the printer 2000 shown in FIG. 1 and are realized by the CPU 12 executing the control programs loaded in the RAM 19.

First, at step S501, as described with reference to phase S205 of FIG. 2, upon receiving a request for acquiring job list information from the host computer 1000, the CPU 12 acquires normal-user name information transmitted from the host computer 1000 as login user information at step S502 (as described with reference to phase S203 of FIG. 2). As print jobs are submitted, the CPU 12 spools the submitted jobs and manages the order of printing assigned to each job based on registered information in the print processing wait queue. Also, job information associated with each print job is managed. This job information may be part of the information stored in the print processing wait queue. Alternatively, the job information may be stored in another memory management area separated from the print process wait queue and may be linked to each job registered in the print process wait queue. FIG. 11 shows an example of the job information management status in the print process wait queue when the job information is part of the information stored in the print process wait queue. The job information shown in FIG. 11 includes job information on both the currently processed job and waiting jobs. Therefore, the print process wait queue may be simply referred to as a “print process queue”.

Subsequently, the process proceeds to step S503, where the printer 2000 initializes a subsequent-job counter and a print page accumulating counter to “0”. At step S504, the printer 2000 lists job handle information (a job ID) of jobs processed in the printer 2000 in descending order of processing (in order of low to high process priority).

At step S505, one job handle is retrieved from the listed job handle information (i.e., a job handle having the lowest job priority is first retrieved). Then, the owner attribute information is acquired from the retrieved job handle.

Subsequently, at step S506, the owner information of the retrieved job is compared with the user name received from the host computer 1000. At step S507, the CPU 12 determines whether or not the names match. If the names match, the process proceeds to step S508, where the document name (job name), the print page count, a job status (process status), and the print request reception date and time for the retrieved job handle are further acquired. At step S509, all the information for the retrieved job handle is added to generation data used for generating a print job list display page.

However, if, at step S507, the CPU 12 determines that the names do not match, the process proceeds to step S510, where the CPU 12 further determines whether generation data used for generating a print job list display page includes attribute information of a job having the same login user name. If the generation data already includes the attribute information, the process proceeds to step S511, where the print page count, a job status (process status), and the print request reception date and time for the retrieved job handle are acquired. At step S512, the document name (job name) and the owner information are converted to the text “*****” in order to mask the information. Thus, simplified job information is created. The process then proceeds to step S509, where the attribute information for the job handle is added to the generation data. The first time the process proceeds to step S511 is the first time job information matching the login information (i.e., checked information) is found.

Additionally, the information created at steps S511 and S512 corresponds to the simplified job information created by removing at least part of information from the information of a job not matching the checked information (login information in FIG. 2). At steps S511 and S512, simplified information is created by removing job information DM and IM2 from job information DM and IM1 through IM3.

A print job list shown in FIG. 5 is only an example. A job information item other than the document name (job name) and the owner name, for example, the submission date and time IM4 may be hidden. That is, part of information may be flexibly changed to the characters “*****” shown in FIG. 5 in order to hide it.

If, at step S510, the CPU 12 determines that the generation data does not include the attribute information of a job having the same login user name yet, the process proceeds to step S513, where the subsequent-job counter is incremented by one. At step S514, the print page attribute of the job handle is acquired. At step S515, a value indicating the print page count, which is part of the acquired information, is added to the print page accumulating counter, and then the process proceeds to step S516. The job information created at steps S513 to S515 is regarded as simplified information, since part of job information is removed compared to the job information created at steps S508 and S509 to be returned. This simplified information includes less information than the job information created at steps S511 and S512.

At step S516, the CPU 12 determines whether all the listed job handle information is processed. If an unprocessed job handle is found, processing returns to step S505 and steps S505-S516 are repeated until all the job handles are processed.

If, at step S516, the CPU 12 determines that all the listed job handle information is processed, the process proceeds to step S517, where the data of the print job list display page is sorted in ascending order of printing (in order of earliest submission date and time). The CPU 12 then creates HTML data and returns it to the host computer 1000. In addition, at step S518, the CPU 12 creates HTML data showing the subsequent job information based on information in the subsequent-job counter and in the print page accumulating counter and returns it to the host computer 1000. The process is then completed. The job information created at step S518 is simplified job information, since this information is created by retrieving part of information from each job among a plurality of jobs not matching the check information (login information in the case of FIG. 2) and integrating the retrieved information.

Thereafter, based on HTML data created in accordance with a flow chart in FIG. 7, the CPU 1 displays a print job list page on the CRT 10 of the host computer 1000 via a WEB browser running on the host computer 1000, as shown in FIG. 5.

In the example in FIG. 5, the login user is “muto”. The job information of jobs whose owner name is not the login user name “muto” is displayed with the document name and owner name information masked using masking symbols “*****”.

Additionally, job information of the jobs having the processing order (printing order) subsequent to the last job whose owner name is the login user name “muto” is simplified as subsequent job information that displays only the number of jobs and the total print page count. Consequently, the communication time with the printer 2000 required for the display process is reduced, thus eliminating traffic problems.

According to the above-described process, a login user can monitor the presence of the previous jobs and their status while masking other users' jobs, which require security. At the same time, the login user can monitor the status of the user's own jobs in detail. Thus, a job list can be efficiently displayed with a simpler configuration while maintaining security, compared to the known job list display method.

### Second Embodiment

In the first embodiment, a job list display process in a normal user mode is described. A job list display process in an administrator mode will be described next in detail as a second embodiment.

FIG. 8 shows a flow chart illustrating an example of a second data processing procedure in a printing apparatus according to the present invention. This data processing procedure corresponds to a process for generating a print job list page to be returned in phase S206 of FIG. 2 and its returning process when login information transmitted from the host computer 1000 in phase S203 of FIG. 2 is in the administrator mode. Control procedures in steps S601 to S608 are stored, as control programs, in the ROM 13 of the printer 2000 shown in FIG. 1 and are realized by the CPU 12 executing the control programs loaded in the RAM 19.

First, at step S601, as described with reference to phase S205 of FIG. 2, upon receiving a request for acquiring job list information from the host computer 1000, the CPU 12 acquires login user information transmitted from the host computer 1000 at step S602 (as described in phase S203 of FIG. 2). At step S603, the CPU 12 determines whether the received login user information is in an administrator mode. If it is determined that it is in an administrator mode, the process proceeds to step S604, where the CPU 12 lists job handle information (job IDs) of jobs being processed in the printer 2000 in ascending order of processing (in order of high to low process priority).

At step S605, one job handle is retrieved from the job handle information listed at step S604. Then, attribute information, namely, the document name (job name), job status (process status), owner, print page count, and submission date and time are acquired from the retrieved job handle. At step S606, all the attribute information for the retrieved job handle is added to generation data used for generating a print job list display page.

At step S607, the CPU 12 determines whether all of the listed job handle information is processed. If the CPU 12 determines that an unprocessed job handle exists, the CPU 12 repeats steps S606-S607 until all the job handles are processed.

If the CPU 12 determines that all the job handles are processed, the process proceeds to step S608, where the CPU 12 creates HTML data based on data of a print job list display page created at step S606. The CPU 12 returns the HTML data to the host computer 1000. The process is then completed.

If, at step S603, the CPU 12 determines that the received login user information is not in an administrator mode, that is, the CPU 12 determines that the received login user information is in a normal user mode, processing proceeds to step S503 shown in FIG. 7.

Thereafter, a print job list page is displayed by a WEB browser running on the host computer 1000 based on the HTML data generated by the procedure shown by the flow chart in FIG. 8. For example, as shown in FIG. 6, a list page screen is displayed on the CRT 10 of the host computer 1000 under the control of the CPU 1.

In particular, as shown in FIG. 6, when the login user is an administrator, all of the detailed information that is hidden in the screen of FIG. 5 is displayed without masking. Also, information of all print jobs being processed in the printer 2000 is displayed in the form of a list. Therefore, the administrator can monitor all of the detailed current job processing statuses including user names in the printer 2000.

Thus, in the administrator mode, a user name and a document name that are masked for security in a normal user mode, as in the first embodiment, can be monitored in detail on a display unit of the administrator's information processing apparatus. Additionally, the job list display screen can be changed in accordance with the use and the required function.

As in the first embodiment, the communication procedure for processing a job list in the second embodiment is simpler and more efficient, compared with known job list display processes.

### Third Embodiment

In the second embodiment, two types of determination of user information, namely, an administrator mode and a normal user mode are described. However, job information may be masked depending on each user. In addition, each user requesting a print job list may determine whether a masking process is required or not.

Thus, a system adaptable to the monitoring environment that is more suitable for individual users' needs can be configured.

### Fourth Embodiment

A step in which the CPU 12 counts a predetermined elapsed time and determines whether the status of information in the queue in the printer 2000 is changed may be added to, for example, a position after step S518 in FIG. 7 or after step S608 in FIG. 8. If the status is changed, the process returns to a predetermined step (step S505 in FIG. 7 or step S603 in FIG. 8), where the same monitoring process is carried out. Then, the latest job list information may be returned to the host computer 1000, which automatically updates and displays the job list.

### Fifth Embodiment

In the above-described embodiments, a user can monitor the job processing status on a screen in which a job list is displayed. In addition, a button may be provided so as to change the processing order of the user's job waiting for processing. By using the button, a user may change the order of processing of the user's job spooled in the printer 2000 or may cancel the job.

### Sixth Embodiment

In the above-described embodiments, only the total print page count is displayed in the monitor information IM3 on a screen showing a job list. In cooperation with the fifth embodiment, the print page count may be displayed as a numerator of a fraction and the total print page count may be displayed as a denominator of the fraction. Thus, the processing status of the pages may be displayed in real time.

### Seventh Embodiment

In the above-described embodiments, a job list in only one printer 2000 is displayed in an administrator mode. However, the same process may be carried out for a plurality of printers in a network. In this case, icons for the listed network printers are displayed on a screen. By selecting one of the icons as a communication target, the same process may be cyclically carried out for each printer.

### Eighth Embodiment

In the above-described embodiments, information of jobs subsequent to the user's own job is simplified and displayed as the number of jobs, etc. However, the display of this information may be eliminated. In this case, it is a design factor whether the printer 2000 does not create information on the subsequent jobs or whether the host computer 1000 discards the received information on the subsequent jobs.

In addition, a button for displaying the information on the subsequent jobs may be provided on the screen shown in FIG. 5 or 6 so that a user can select whether the information on the subsequent jobs is displayed or not.

In the above-described embodiments, a character is used to mask job information. However, any text character and symbol may be used in place of “*”.

Furthermore, the present invention includes the case where a file name is masked and the file extension is not masked when displaying a job name.

### Ninth Embodiment

In the above-described embodiments, the output of job management information (i.e., a print job list) from the printer 2000 in a normal user mode is described as in the description of M2 in FIGS. 3 and 4. Also, the display process of the job management information by the host computer 1000 is described.

More specifically, as shown in FIGS. 5-6, job information of the jobs to be printed subsequent to the user's (login user's) last job is integrated together and is displayed as the number of subsequent jobs, in a simplified manner.

However, the present invention is not limited to the displays shown in FIGS. 5-6. Another form of display may be applied. As described with reference to phase S203 of FIG. 2, the printer 2000 receives a request for returning job management information (e.g., a print job list) containing information of each job among a plurality of jobs in the printer 2000. Simultaneously, the printer 2000 receives check information (e.g., a user name and an authentication password, which are part of login information). Then, the printer 2000 can create job management information (e.g., a print job list) including simplified job information, in which at least part of information of a job not matching the check information is eliminated, and information of a job matching the check information, regardless of the printing order. In the created job management information, the order of printing of jobs matching and not matching the check information can be recognized.

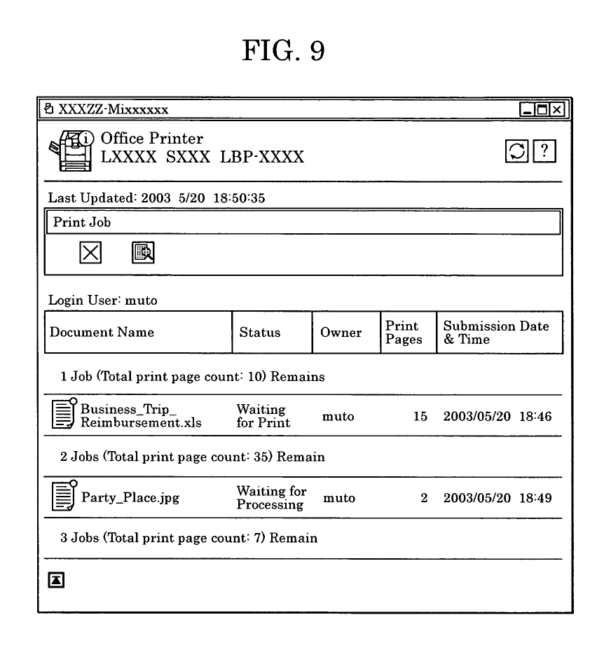

The processing in other forms of display in place of FIGS. 5-6 will be described next with reference to FIGS. 9-11.

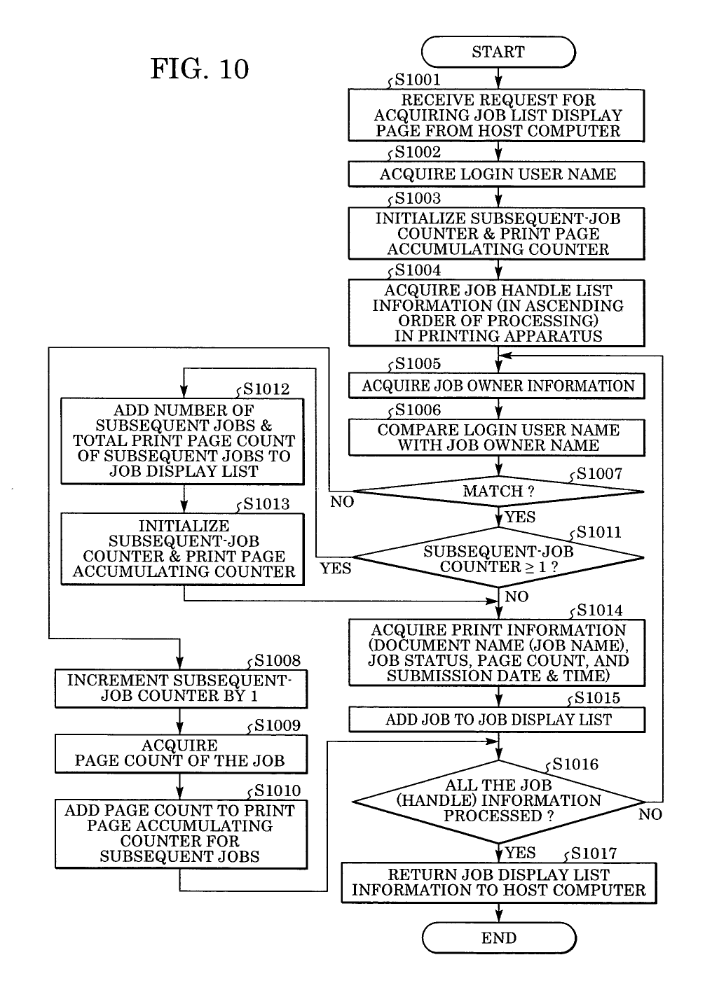

FIG. 10 shows a flow chart of an example of a data processing procedure different from FIG. 7 in a printing apparatus according to the present invention. This procedure corresponds to the procedure for creating a print job list page returned in phase S206 when login information transmitted from the host computer 1000 is in a normal user mode in phase S203 of FIG. 2.

Control procedures in steps S1001 to S1017 are stored, as control programs, in the ROM 13 of the printer 2000 shown in FIG. 1 and are realized by the CPU 12 executing the control programs loaded in the RAM 19.

First, at step S1001, the CPU 12 receives a request for acquiring a job management information display page (e.g., a print job list), as described with reference to phase S205 of FIG. 2.

Upon receiving the acquiring request, the CPU 12, at step S1002, acquires normal-login-user name information from the check information (login user information) transmitted from the host computer 1000 in phase S203 of FIG. 2. Although a normal user name is used in the flow chart, any check information that can identify the user may be used. For example, an IP address of the host computer 1000 may be used.

Subsequently, the process proceeds to step S1003, where the CPU 12 initializes a subsequent-job counter and a print page accumulating counter to “0” contained in WEB content to be transformed. At step S1004, the printer 2000 extracts job handle information (job IDs) of jobs being processed in the printer 2000 in ascending order of processing (in order of high to low process priority) to list the information.

At step S1005, a job handle having the highest job priority is retrieved from the listed job handle information in ascending order (i.e., a job handle printed earlier is retrieved). Then, the owner attribute information (the owner name) of a job corresponding to the retrieved job handle is retrieved based on the job information managed by a print process queue shown in FIG. 11. In the example of FIG. 11, an “owner” item 1111 is retrieved.

Subsequently, at step S1006, the owner information of the retrieved job is compared with the user name received from the host computer 1000 as the check information. At step S1007, the CPU 12 determines whether or not the names match. If the names do not match, the process proceeds to step S1008, where the CPU 12 increments the subsequent-job counter by one. At step S1009, the CPU 12 acquires the print page attribute of the job handle. At step S1010, the CPU 12 adds the value indicating the acquired print page count to the print page accumulating counter. The process then proceeds to step S1016.

However, if, at step S1007, the names match, the process proceeds to step S1011, where the CPU 12 determines whether the subsequent-job counter value is greater than or equal to “1”. Here, the subsequent-job counter value of greater than or equal to “1” indicates the presence of job information that has not yet been converted to a markup language. This job information is converted to a markup language (e.g., HTML) at step S1012, as will be described later.

If, at step S1011, the CPU 12 determines that the subsequent-job counter value is greater than or equal to “1”, the process proceeds to step S1012, where the number of subsequent jobs and the total page count of the subsequent jobs are added to generation data used for creating a print job list display page based on the information in the subsequent-job counter and the print page accumulating counter. At step S1013, the subsequent-job counter and the print page accumulating counter are initialized to “0”. The process then proceeds to step S1014.

If, at step S1011, the CPU 12 determines that the subsequent-job counter value is equal to “0”, the process proceeds to step S1014, where the attribute information, namely, the document name (job name), print page count, job status (process status), and submission date and time of a job corresponding to the job handle, is acquired. At step S1015, all the information for the retrieved job handle is added to generation data used for generating a print job list display page. The process then proceeds to step S1016.

At step S1016, the CPU 12 determines whether all the listed job handle information is processed. If the CPU 12 determines that an unprocessed job handle exists, processing returns to step S1005 and the processing of steps S1005-S1016 is repeated until all the job handles are processed.

If, at step S1016, the CPU 12 determines that all the job handles are processed, the process proceeds to step S1017, where the CPU 12 returns the created data of a print job list display page (HTML data) to the host computer 1000. The process is then completed.

For example, the following procedures output job management information shown in FIG. 9: steps S1001 to S1006, No at step S1007, steps S1008 to S1010, and No at step S1016; then, steps S1001 to S1006, Yes at step S1007, No at step S1011, steps S1014 to S1015, and No at step S1016; then, two iterations of steps S1001 to S1006, No at step S1007, steps S1008 to S1010, and No at step S1016; then, steps S1001 to S1006, Yes at step S1007, No at step S1011, steps S1014 to S1015, and No at step S1016; then, steps S1001 to S1006, No at step S1007, steps S1008 to S1010, and No at step S1016; and finally, steps S1001 to S1006, No at step S1007, steps S1008 to S1010, and Yes at step S1016. As a result, the created job management information is output from the printer 2000 to the host computer 1000.

Furthermore, as an extension of the process shown in FIG. 10, job management information including job information of a job matching the check information and being capable of identifying the order of printing of jobs matching and not matching the check information may be created to be externally output.

In this case, the information capable of identifying the order of printing of jobs matching and not matching the check information includes the information as to what printing order is assigned to a job matching the check information and the information as to how long a job to be printed prior to the user's job requires before the job finishes printing.

### Tenth Embodiment

The printer 2000 may include a search unit for searching for a last job to be printed last from among at least one job matching the check information from the host computer 1000. Information of jobs to be printed prior to the last job found by the search unit may be created as first simplified job information (corresponding to OT1, OT2, and OT3 in FIG. 5), and information of jobs to be printed subsequent to the last job may be created as second simplified job information (corresponding to M in FIG. 5).

### Eleventh Embodiment

In the above-described embodiments, the printing system separately includes the host computer 1000 and the printer 2000. However, the present invention is not limited thereto. For example, the present invention can be applied to image processing apparatuses including a document reading unit, such as a scanner, display unit, such as an operation display unit, and a printing control unit, such as a print controller (e.g., digital multifunction printers). In this case, the steps of the flow chart described in each embodiment are executed for print jobs based on images scanned by the document reading unit of the image processing apparatus. Additionally, the screens shown in FIGS. 5, 6, and 9 are displayed on the display unit of the image processing apparatus.

### Twelfth Embodiment

In the above-described embodiments, the printing apparatus creates job management information stored in the print process queue. However, the present invention is not limited thereto. The host computers 1000 and 1001 may input all the job management information shown in FIG. 11 or necessary part of the information to execute the steps subsequent to step S502 in FIG. 7 or the steps subsequent to step S1002 in FIG. 10. In this case, steps S517, S518, and S1017 carry out an output process to a display unit of the host computers 1000 and 1001. Also, at steps S507 and S510, the check information (login information) of a requester who requests job management information to the printing apparatus is referred to. This method simplifies the configuration of the printing apparatus. In addition, software in the host computers 1000 and 1001 can achieve the present invention.

According to the above-described embodiments, the most advantageous feature is that a viewing restriction can be attached to job information of a print job to which the order of printing is assigned and which is managed by a print wait queue. In addition, a viewing restriction is not only attached to job information of a print job managed by a print wait queue, but also job management information (e.g., a print job list) having a flexible and appropriate viewing restriction can be output depending on a user (authentication information) requesting the job management information. Consequently, the originally expected job management function can be achieved with improved security and privacy protection compared to known methods.

The present invention provides a significantly advanced technology in which a viewing restriction is assigned to each file stored in a storage unit, such as a hard disk and only an authorized login user is allowed to view or access the file having the viewing restriction.

Furthermore, masking another user's job information allows a user to monitor the job waiting status while maintaining confidentiality. Also, since subsequent job information which does not have an impact on the user's job is not displayed, the amount of required information is reduced when displaying the job list. As a result, the job list can be more efficiently displayed.

Still furthermore, it is determined whether a user has an administrative right. If the user has an administrative right, all the job information and job status in a printing apparatus are displayed for the user without masking the job information. Consequently, information of the printing apparatus can be provided to all users using a WEB browser while the administrative user can manage the printing apparatus without problem.

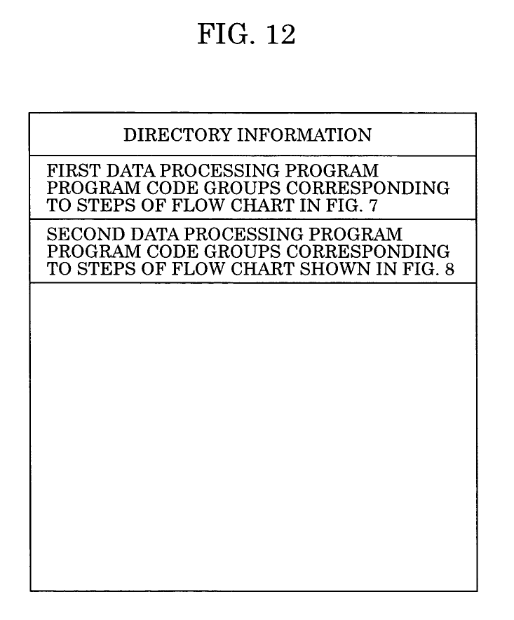

The configuration of a data processing program readable by a printing apparatus and a printing system including an information processing apparatus according to the present invention will be described next with reference to a memory map shown in FIG. 12.

FIG. 12 shows a memory map of a recording medium for storing a variety of data processing programs readable by a printing apparatus and a printing system including an information processing apparatus according to the present invention.

Although not shown, management information for managing the programs stored in the recording medium, such as version information and an author, is also stored. In addition, information depending on an OS which reads out the programs, for example, an icon for identifying the program, may be stored.

Data for each program is also managed in a directory of the memory map. A program for installing each program in a computer may be stored. Furthermore, if the program to be installed is archived, a program for unarchiving the program may be stored.

According to the embodiment, the function described in relation to FIGS. 7 and 8 may be achieved by the host computer executing a program externally installed. The present invention can be applied to this case, where information including the programs is supplied from an external recording medium to an output unit via a recoding medium, such as a CD-ROM (compact disk—ROM), a flash memory, and a flexible disk (FD), or via a network.

The present invention can be achieved by supplying a recording medium storing program code of software that achieves the functions of the above-described embodiments to a system or a device and by causing a computer (CPU (central processing unit) or MPU (micro-processing unit)) of the system or device to input and execute the program stored in the recording medium.

In such a case, the program code of the software achieves the specific functions of the present invention by itself.

Thus, any form of the program, such as object code, a program executed by an interpreter, and script data supplied to the OS, is allowed as long as the program has the function.

The recording medium for supplying the program includes, for example, a flexible disk, a hard disk, an optical disk, a magneto optical disk (MO), a CD-ROM (compact disk—read-only memory), a CD-R (compact disk—recordable), a CD-RW (compact disk—rewritable), a magnetic tape, a nonvolatile memory card, a ROM, and a DVD (digital versatile disk).

In addition, the program may be supplied by accessing a home page on the Internet using a browser in a client computer and downloading the computer program of the present invention or an archive file including an auto-install function from the home page to a recording medium, such as a hard disk. Furthermore, program code of the program of the present invention may be divided into a plurality of files, which may be downloaded from different home pages. In other words, a WWW (world wide web) server and an FTP (file transfer protocol) server that allow a plurality of users to download a program file that achieves the functions of the present invention are also included in the present invention.

Additionally, the program according to the present invention can be encrypted and stored into a recoding medium, such as a CD-ROM, to deliver it to users. A user who satisfies a predetermined criterion can download key information for decrypting the encryption from a home page on the Internet. By using the key information, the user can install the encrypted program in a computer and can execute the program to achieve the present invention.

Additionally, in addition to achieving the functions of the above-described embodiments by the computer executing the readout program, the functions of the above-described embodiments can be achieved by a process in which an OS running on the computer executes some of or all of the effective functions in response to instructions of the program.

Furthermore, the functions of the above-described embodiments can be achieved by a process in which, after a program read from a recording medium is stored in a memory of an add-on expansion board inserted in a computer or a memory of an add-on expansion unit connected to a computer, a CPU in the add-on expansion board or in the add-on expansion unit executes some of or all functions described in the above-described embodiments.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-132966 filed Apr. 28, 2004, and Japanese Patent Application No. 2005-048811 filed Feb. 24, 2005, which are hereby incorporated by reference herein.

1. A printing system comprising:
a processing wait queue capable of identifying an order of printing of submitted jobs;
a storing unit configured to store a submitted job in the processing wait queue;
a receiving unit configured to receive both a request for acquiring job management information and check information on the submitted job stored in the processing wait queue;
a creation unit configured to create job management information including simplified job information created by removing at least part of information from job information of a submitted job not matching the check information and job information of a submitted job matching the check information, the job management information being capable of identifying the order of printing of the submitted jobs matching and not matching the check information; and
an output control unit configured to cause the job management information created by the creation unit to be externally output.

2. The printing system according to claim 1, further comprising:
a print unit configured to sequentially carry out printing of the submitted jobs based on information stored in the processing wait queue.

3. The printing system according to claim 1, wherein the submitted jobs not matching the check information include submitted jobs to be printed prior to and subsequent to a last submitted job to be printed last among at least one submitted job matching the check information, and the creation unit creates the job management information including both first simplified job information on the submitted job to be printed prior to the last submitted job and second simplified job information on the submitted job to be printed subsequent to the last submitted job.

4. The printing system according to claim 3, wherein the first simplified job information is job information in which part of the job information is changed to be hidden with a mask and the second simplified job information is job information in which job information on a plurality of submitted jobs to be printed subsequent to the last submitted job are integrated together in a summarized format.

5. The printing system according to claim 3, further comprising:
a reading unit configured to sequentially read job information on submitted jobs stored in the processing wait queue in descending order of waiting; and
a checking unit configured to sequentially check the sequentially read out job information against the check information;
wherein the creation unit creates the second simplified job information from the information of a submitted job not matching the check information detected, based on the check by the checking unit, before job information matching the check information is found, and the creation unit creates the first simplified job information from the information of a submitted job not matching the check information detected after the job information matching the check information is found.

6. The printing system according to claim 3, further comprising:
a search unit configured to search for a last submitted job to be printed last among at least one of submitted jobs matching the check information;
wherein the creation unit creates the first simplified job information from the information of a submitted job to be printed prior to the last job searched for by the search unit, and the creation unit creates the second simplified job information from the information of a submitted job to be printed subsequent to the last job searched for by the search unit.

7. The printing system according to claim 1, wherein the job management information is a job list.

8. The printing system according to claim 1, further comprising:
a printing apparatus; and
an information processing apparatus capable of communicating with the printing apparatus;
wherein the submitted job is a job transmitted from the information processing apparatus to the printing apparatus.

9. The printing system according to claim 1, wherein the printing system is an image processing apparatus comprising:
a document reading unit;
a display unit; and
a print control apparatus;
and wherein the submitted job is created based on an image read out by the document reading unit.

10. A method for managing a submitted job in a printing system, the printing system comprising a processing wait queue capable of identifying an order of printing of submitted jobs, the method comprising:
a storing step of storing the submitted job in the processing wait queue;
a receiving step of receiving both a request for acquiring job management information and check information on the submitted job stored in the processing wait queue;
a creation step of creating job management information including simplified job information created by removing at least part of information from job information of a submitted job not matching the check information and job information of a submitted job matching the check information, the job management information being capable of identifying the order of printing of the submitted jobs matching and not matching the check information; and
an output control step of causing the job management information created by the creation step to be externally output.

11. The method according to claim 10, further comprising:
a print step of sequentially carrying out printing of the submitted jobs based on information stored in the processing wait queue.

12. The method according to claim 10, wherein the submitted jobs not matching the check information include submitted jobs to be printed prior to and subsequent to a last submitted job to be printed last among at least one submitted job matching the check information, and the creation step creates the job management information including both first simplified job information on the submitted job to be printed prior to the last submitted job and second simplified job information on the submitted job to be printed subsequent to the submitted last job.

13. The method according to claim 12, wherein the first simplified job information is job information in which part of the job information is changed to be hidden with a mask and the second simplified job information is job information in which job information on a plurality of submitted jobs to be printed subsequent to the last submitted job are integrated together in a summarized format.

14. The method according to claim 12, further comprising:
a reading step of sequentially reading job information on submitted jobs stored in the processing wait queue in descending order of waiting; and
a checking step of sequentially checking the sequentially read out job information against the check information;
wherein the creation step creates the second simplified job information from the information of a submitted job not matching the check information detected, based on the check by the checking step, before job information matching the check information is found, and the creation step creates the first simplified job information from the information of a submitted job not matching the check information detected after the job information matching the check information is found.

15. The method according to claim 12, further comprising:
a search step of searching for a last submitted job to be printed last among at least one of submitted jobs matching the check information;
wherein the creation step creates the first simplified job information from the information of a submitted job to be printed prior to the last submitted job searched for by the search step, and the creation step creates the second simplified job information from the information of a submitted job to be printed subsequent to the last submitted job searched for by the search step.

16. The method according to claim 10, wherein the job management information is a job list.

17. The method according to claim 10, wherein the printing system further comprises:
a printing apparatus; and
an information processing apparatus capable of communicating with the printing apparatus;
and wherein the submitted job is a job transmitted from the information processing apparatus to the printing apparatus.

18. The method according to claim 10, wherein the printing system is an image processing apparatus comprising:
a document reading unit;
a display unit; and
a print control apparatus;
and wherein the submitted job is created based on an image read out by the document reading unit.

19. A program for causing a computer to execute a method according to claim 10.

20. A storage medium storing a computer-readable program for causing a computer to execute a method according to claim 10.

21. A program for causing a computer to execute a method of managing a print job in a printing system capable of communicating with a printing apparatus, the printing apparatus comprising a processing wait queue capable of identifying an order of printing of submitted jobs, a storing unit configured to store the submitted jobs in the processing wait queue, and a management unit configured to manage job management information of a submitted job stored in the processing wait queue, the program comprising:
an acquiring step of acquiring job management information from the printing apparatus;
a creation step of creating job management information including simplified job information created by removing at least part of information from job information of a submitted job not matching check information on a requester requesting the job management information and job information of a submitted job matching the check information, the job management information being capable of identifying the order of printing of the submitted jobs matching and not matching the check information; and
an output control step of causing the job management information created by the creation step to be externally output.

22. A printing system comprising:
a processing wait queue capable of identifying an order of printing of submitted jobs;
a storing unit configured to store a submitted job in the processing wait queue;
a receiving unit configured to receive both a request for acquiring job management information and check information on the submitted job stored in the processing wait queue;
a creation unit configured to create job management information including job information of a job matching the check information, the job management information being capable of identifying the order of printing of the submitted jobs matching and not matching the check information; and
an output control unit configured to cause the job management information created by the creation unit to be externally output.
